(19) United States
(12) Patent Application Publication
(10) Pub. No.: US 2019/0119552 A1
(43) Pub. Date: Apr. 25, 2019

(54) ACID SOLUBLE DIVERTING AGENTS FOR REFRACTURING APPLICATIONS

(71) Applicant: The Board of Regents of The University of Texas Sytem, Austin, TX (US)

(72) Inventor: Mukul M. Sharma, Austin, TX (US)

(21) Appl. No.: 15/772,605

(22) PCT Filed: Nov. 2, 2016
(86) PCT No.: PCT/US16/60007

§ 371 Date: May 1, 2018

Related U.S. Application Data
(60) Provisional application No. 62/249,746, filed on Nov. 2, 2015.

(51) Int. Cl. C09K 8/42; C09K 8/70; E21B 33/138; C09K 8/66

(52) U.S. Cl. CPC C09K 8/426; C09K 8/70; C09K 8/80; C09K 8/66; C09K 2208/08; E21B 33/138

(57) ABSTRACT

A method for treating an oil-bearing subsurface formation is disclosed that includes providing one ore more acid soluble materials into a wellbore in the oil-bearing subsurface formation. The wellbore may include a plurality of first perforations in the wellbore that have been used to form first fractures emanating from the wellbore in the formation. The acid soluble materials may be used as a diverting agent to form plugs in existing perforations in the wellbore. The plugs may inhibit fluid flow through the existing perforations. The plugs may be removed at any time desired by providing an acid into the wellbore or by incorporating a delayed source of acid in the diverting agent.

### BACKGROUND OF THE INVENTION

### 1. Field of the Invention

Embodiments described herein relate to systems and methods for subsurface reservoir technology. More particularly, embodiments described herein relate to systems and methods for refracturing wellbores in subsurface oil and gas-bearing formations.

### 2. Description of the Relevant Art

Hydraulic fracturing has become a major driver of oil and gas production in United States land operations. Some oil and gas-bearing formations (e.g., oil and gas-bearing resources) may have very low permeability compared to conventional resources. These oil and gas-bearing formations are often stimulated using hydraulic fracturing techniques to enhance oil and gas production. Long horizontal wells are often used to provide suitable commercial production from these formations. However, it is common to only recover 5-15% of the original oil-in-place due to depletion and high decline rates seen in many wells (e.g., shale wells). For example, it is not uncommon to see more than 60% decline in production rates after one year. Initial well completions may leave some zones in the formation under-stimulated and/or unaccessed.

Refracturing (fracturing a well that has been previously fractured) is being explored to attempt to increase oil recovery from these formations using vertical, deviated, and/or horizontal wells. Refracturing may increase oil production from previously fractured formations by potentially accessing under-stimulated zones and/or different parts of the oil-bearing reservoir. Refracturing typically uses diverting agents to temporarily block off permeable sections (fractures) of the well and force fracturing fluid and sand into new fractures and/or into less permeable fractures to create new and/or larger fractures. Currently used diverting agents, however, can be unreliable and costly. For example, self-degrading polymers (such as polylactic acid) are commonly used as diverting agents for refracturing. Self-degrading polymers, however, are expensive to use and incur several problems when used in subsurface formations. One problem is that the self-degrading polymer often precipitates in the presence of high salinity brines encountered in subsurface fracturing wells. These precipitates may cause clogging and restrict flow through the well. Because the polymer degrades in the well, it also can often leave residue in the well, which may be environmentally detrimental.

Another significant problem with self-degrading polymers is that they are temperature sensitive. For example, self-degrading polymers may degrade at temperatures encountered in the fracturing well. To avoid degradation of the polymer too quickly, the polymer molecular weight is sometimes adjusted to create a specific chemistry for the specific temperatures in the well. High molecular weight polymers usually require a higher temperature and more time to degrade. Preparing the proper chemistry for the specific temperatures in the well can be costly, labor intensive, and unreliable. In some cases, if the well work does not go according to the schedule, the polymer may degrade before the new fracturing treatment is pumped. In other cases, the polymer may not degrade sufficiently or the products of the degradation may result in precipitates that do not clean up during flowback. Thus, there is a need for a diverting agent that improves the reliability of refracturing and reduces costs to make refracturing formations more economically and commercially feasible.

Acid soluble diverting agents have been used before in oil and gas wells as additives to drilling fluids and fracturing fluids. However, they have not been used or contemplated for use in refracturing applications. The use of diverting agents in refracturing applications is substantially different than their use in other applications such as drilling or perforating. In refracturing applications, many fractures are open in the wellbore and this can result in a great deal of uncertainty in where the injected fluid is going. As such, it is important to plug these existing perforations before any new ones are pumped. The plugs that are formed must be stable enough to withstand the pressure and flow conditions in the wellbore during multiple stages of fracturing since there is typically no zonal isolation in the wellbore during refracturing. The acid soluble additives must also be able to bridge across the existing perforations and fractures as well as form a very low permeability filter cake so that they can seal them to prevent fluid from being lost into the large number of open perforations. In these and other ways, refracturing offers some unique challenges for the application of acid soluble diverting agents.

### SUMMARY

In certain embodiments, a method for treating an oil and gas-bearing subsurface formation includes providing at least one acid soluble material into a wellbore in the oil-bearing subsurface formation. The wellbore may include a plurality of first perforations in the wellbore that have been used to form first fractures emanating from the wellbore in the formation. The at least one acid soluble material may form a plug in one or more of the first perforations. The plug may inhibit fluid flow through such first perforations. One or more second perforations may be formed in the wellbore. One or more fracking fluids may be provided into the wellbore to hydraulically stimulate the formation and form second fractures in the formation through the second perforations in the wellbore. The formation of fractures through the first perforations may be inhibited by the plugs formed by the at least one acid soluble material.

In certain embodiments, a method for treating an oil and gas-bearing subsurface formation includes providing a mixture of two or more acid soluble materials into a wellbore in the oil-bearing subsurface formation. The wellbore may include a plurality of first perforations in the wellbore that have been used to form first fractures in the formation emanating from the wellbore. At least two of the acid soluble materials may combine to form a plug in one or more of the first perforations. The plug may inhibit fluid flow through such first perforations. One or more second perforations may be formed in the wellbore. One or more fracking fluids may be provided into the wellbore to hydraulically stimulate the formation and form second fractures in the formation through the second perforations in the wellbore. The formation of fractures through the first perforations may be inhibited by the plugs formed by the at least two acid soluble materials.

In certain embodiments, a system configured to treat an oil and gas-bearing subsurface formation includes: a first acid soluble material configured to be provided into a wellbore having a plurality of first perforations that have been used to hydraulically fracture the oil-bearing subsurface formation; and a second acid soluble material, wherein the second acid soluble material is configured to combine with the second acid soluble material to form a plug in one or more of the first perforations to inhibit fluid flow through such first perforations.

In certain embodiments, a method for treating an oil and gas-bearing subsurface formation includes providing at least one acid soluble material into a wellbore in the oil-bearing subsurface formation. The wellbore may include a plurality of first perforations in the wellbore that have been used to form first fractures in the formation emanating from the wellbore. The at least one acid soluble material may form a plug in one or more of the first perforations, the plug inhibiting fluid flow through such first perforations. One or more second perforations may be formed in the wellbore. An acid may be provided into the wellbore to remove the plugs formed by the at least one acid soluble material.

In certain embodiments, a method for treating an oil and gas-bearing subsurface formation includes providing a mixture of one or more acid soluble materials in combination with a delayed source of acid into a wellbore in the oil-bearing subsurface formation. The wellbore may include a plurality of first perforations in the wellbore that have been used to form first fractures in the formation emanating from the wellbore in a hydraulic fracturing process. At least one of the acid soluble materials and the delayed source of acid may combine to form a plug in one or more of the first perforations, the plug inhibiting fluid flow through such first perforations. One or more second perforations may be formed in the wellbore. One or more fracking fluids may be provided into the wellbore to hydraulically stimulate the formation and form second fractures in the formation through the second perforations in the wellbore. Formation of fractures through the first perforations may be inhibited by the plugs formed by the at least one acid soluble material in combination with the delayed source of acid.

In certain embodiments, a method for treating an oil and gas-bearing subsurface formation includes providing a mixture of one or more acid soluble materials and a delayed source of acid into a wellbore in the oil-bearing subsurface formation. The wellbore may include a plurality of first perforations in the wellbore used to form first fractures in the formation emanating from the wellbore in a hydraulic fracturing process. At least one of the acid soluble materials and the delayed source of acid may combine to form a plug in one or more of the first perforations, the plug inhibiting fluid flow through such first perforations. One or more second perforations may be formed in the wellbore. The delayed source of acid may be allowed to form acid in the wellbore. The acid may remove the plugs formed by the at least one acid soluble material and the delayed source of acid.

In certain embodiments, a method for treating an oil and gas-bearing subsurface formation includes providing a mixture of one or more acid soluble materials and a delayed source of acid into a wellbore in the oil-bearing subsurface formation. The wellbore may include a plurality of first perforations in the wellbore used to form first fractures in the formation emanating from the wellbore in a hydraulic fracturing process. At least one of the acid soluble materials and the delayed source of acid may combine to form a plug in one or more of the first perforations, the plug inhibiting fluid flow through such first perforations. One or more second perforations may be formed in the wellbore. The delayed source of acid may be allowed to form a first acid in the wellbore. The first acid may assist in removing the plugs formed by the at least one acid soluble material and the delayed source of acid. A second acid may be provided into the wellbore to assist in removing the plugs formed by the at least one acid soluble material and the delayed source of acid.

### BRIEF DESCRIPTION OF THE DRAWINGS

Features and advantages of the methods and apparatus of the embodiments described in this disclosure will be more fully appreciated by reference to the following detailed description of presently preferred but nonetheless illustrative embodiments in accordance with the embodiments described in this disclosure when taken in conjunction with the accompanying drawings in which:

FIG. 1 depicts representations of embodiments of three different types of fractures that may be present in a wellbore after hydraulic fracturing.

FIG. 1A depicts an enlarged view of a fracture in a formation formed through a perforation in a wellbore.

FIG. 2 depicts a representation of an embodiment of fluid flow in a wellbore.

FIG. 3 depicts a representation of another embodiment of fluid flow in a wellbore.

FIG. 4 depicts a representation of yet another embodiment of fluid flow in a wellbore.

FIG. 5 depicts a schematic representation of an embodiment of a plug structure being formed in a perforation in a formation by a diverting agent.

FIG. 6 depicts a schematic representation of an embodiment of a plug filling a perforation.

FIG. 7 depicts a schematic representation of an embodiment of a plug formed in a perforation on a wellbore.

FIG. 8 depicts a schematic representation of an embodiment of reperforation of a wellbore.

FIG. 9 depicts a schematic representation of an embodiment of refracturing of a wellbore.

FIG. 10 depicts a schematic representation of an embodiment of refracturing of a wellbore with the plug removed.

FIG. 11 depicts a schematic representation of an embodiment of a plug being removed after the refracturing of a wellbore.

FIG. 12 depicts a schematic representation of an embodiment of production from a refractured wellbore.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF THE PREFERRED EMBODIMENTS

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Fractures in oil-bearing subsurface formations as described herein are directed to fractures created hydraulically. It is to be understood, however, that fractures created by other means (such as thermally or mechanically) may also be treated using the embodiments described herein. Examples of oil-bearing subsurface formations include oil shale formations and other low-permeability formations with oil entrained in rock or solids that are hydraulically, thermally, or mechanically fractured to allow production of hydrocarbons from the formation.

“Hydrocarbons” are generally defined as molecules formed primarily by carbon and hydrogen atoms. Hydrocarbons may also include other elements such as, but not limited to, halogens, metallic elements, nitrogen, oxygen, and/or sulfur. Hydrocarbons may be, but are not limited to, natural gas, gas hydrates, kerogen, bitumen, pyrobitumen, oils, natural mineral waxes, and asphaltenes. Hydrocarbons may be located in or adjacent to mineral matrices in the earth. Matrices may include, but are not limited to, sedimentary rock, sands, sandstones, carbonates, diatomites, and other porous media. “Hydrocarbon fluids” are fluids that include hydrocarbons. Hydrocarbon fluids may include, entrain, or be entrained in non-hydrocarbon fluids such as hydrogen, nitrogen, carbon monoxide, carbon dioxide, hydrogen sulfide, water, and ammonia.

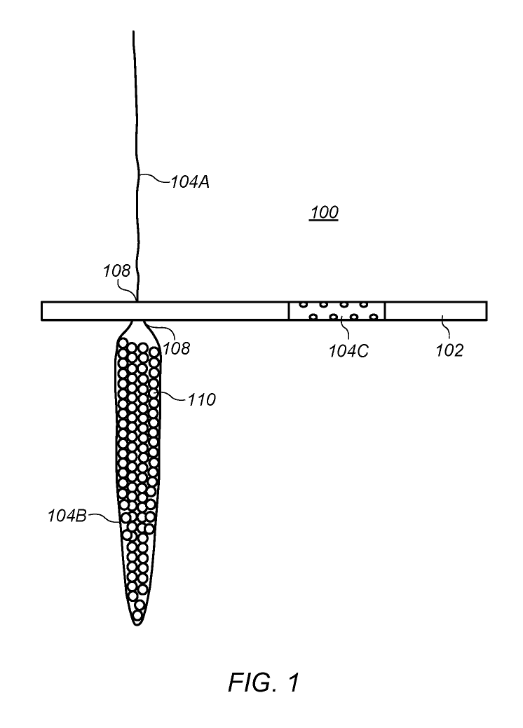

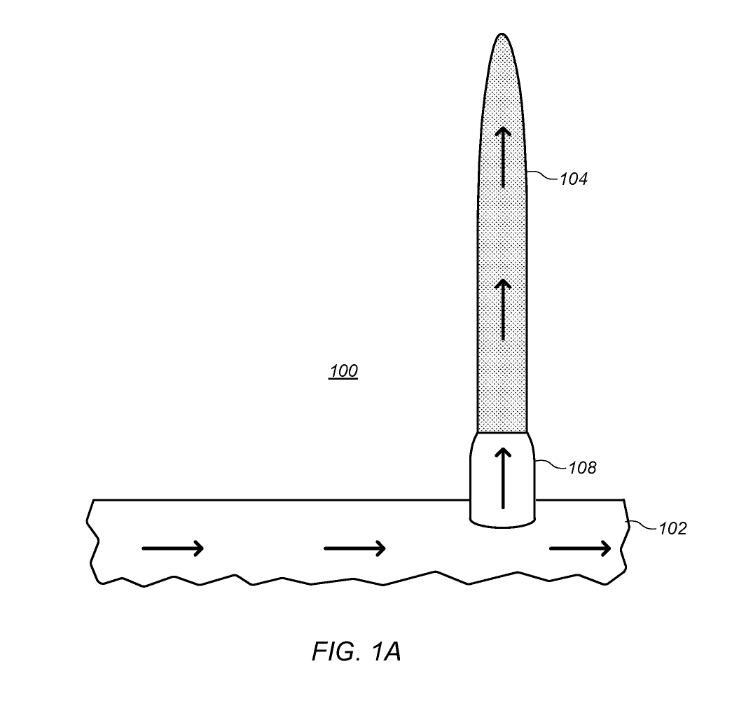

FIG. 1 depicts representations of embodiments of three different types of fractures that may be present in a wellbore after hydraulic fracturing. Formation 100 may be a subsurface oil-bearing formation. Fractures may be formed in formation 100 from wellbore 102. For example, hydraulic fracturing (e.g., fracking) of formation 100 may be performed in wellbore 102. In certain embodiments, wellbore 102 is a horizontal wellbore (e.g., a long horizontal wellbore typically used for hydraulic fracturing). Wellbore 102 may, however, be any orientation of wellbore (e.g., a vertical wellbore or an angled wellbore).

In some embodiments, and for illustration purposes, wellbore fractures can be grouped into three different types of fractures: first fracture type 104A, second fracture type 104B, and third fracture type 104C exist in formation 100 after hydraulic fracturing of the formation. The fractures may be formed through perforations 108 in wellbore 102. FIG. 1A depicts an enlarged view of fracture 104 in formation 100 formed through perforation 108 in wellbore 102.

First fracture type 104A and second fracture type 104B may be fractures that extend from wellbore 102 into formation 100 after the fracturing process. In certain embodiments, first fracture 104A is a hydraulic fracture without proppant and second fracture 104B is a hydraulic fracture with proppant 110 provided into the fracture to “prop open” the fracture. Proppant 110 in second fracture 104B may keep the second fracture from closing after pumping of fluids into wellbore 102 ends. In some embodiments, proppant 110 allows gas and oil to flow more freely into wellbore 102. Third fracture type 104C may be a fracture that is only in the wellbore or near wellbore region and does not extend from the wellbore. Because third fracture type 104C does not extend into formation 100, the third fracture type may not provide as much flow of hydrocarbons from the formation into wellbore 102. After the fracturing process is completed, pressure in wellbore 102 may be reduced (e.g., fracking fluid pumping into the wellbore is ceased) and hydrocarbons (e.g., oil and/or gas) may be produced from the fractures through wellbore 102.

Typically, hydrocarbon production from wellbore 102 declines after a certain period of time due to depletion of pore pressure in formation 100 as fluids are produced. The decline in production may often be high (e.g., greater than 50% or 60% after one year). Once production falls below a certain level, production may be stopped. After production is stopped, however, many zones in formation 100 remain under-stimulated and/or unaccessed from wellbore 102. For example, it is common for only 5-15% of the oil (hydrocarbons) in place in formation 100 to be produced by a single fracturing process from wellbore 102.

In certain embodiments, refracturing in wellbore 102 is used to increase production from the wellbore. Refracturing is the process of hydraulically fracturing a wellbore that has been previously fractured. Refracturing in wellbore 102 may increase access to under-stimulated zones in formation 100 and/or access different parts of the formation not accessed in the original fracturing process (or previous fracturing processes). In some embodiments, refracturing increases production by extension of fracture length, increase in fracture conductivity, and/or reorientation of fractures into new areas of formation 100.

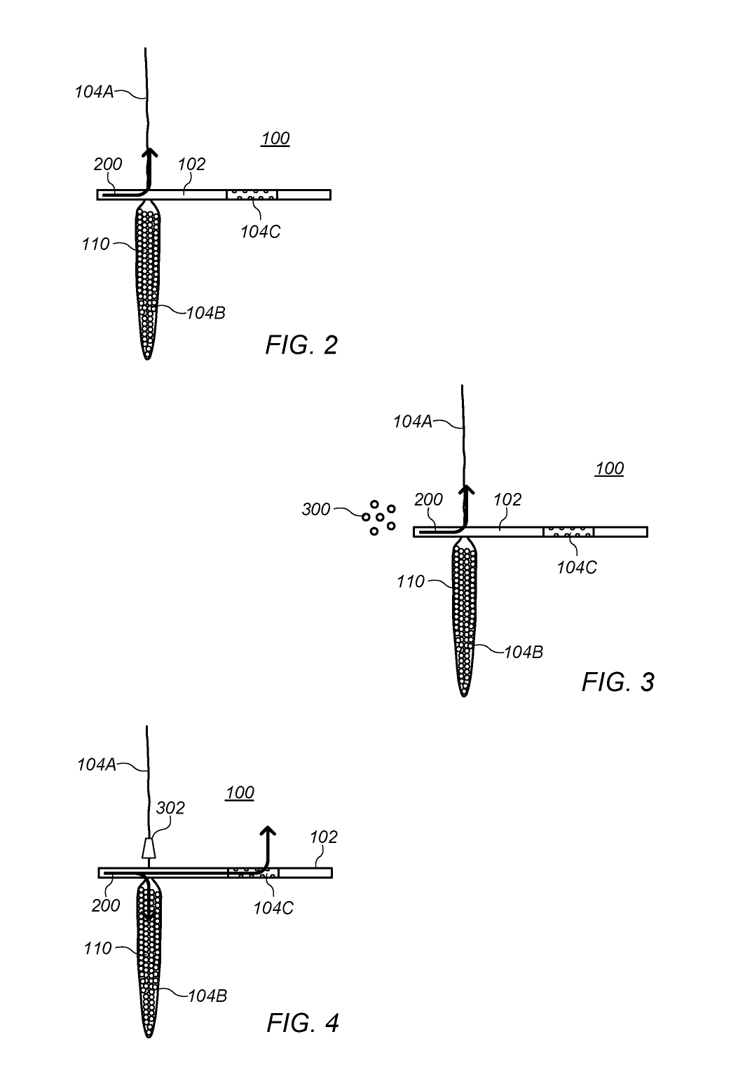

In refracturing processes, diverting agents may be used to plug or stop flow in existing perforations 108 in wellbore 102 (e.g., the perforations created during the previous fracturing process). Plugging flow in the existing perforations allows additional fluids provided to wellbore 102 to flow and be distributed evenly in the wellbore and/or access new areas in and around the wellbore. FIG. 2 depicts a representation of an embodiment of fluid flow in wellbore 102 with first fracture type 104A, second fracture type 104B, and third fracture type 104C. As shown in FIG. 2, in some embodiments, fluid (shown by arrow 200) may preferably flow through first fracture type 104A as the first fracture type may have the lowest pressure barrier (e.g., lowest stress and pore pressure).

In FIG. 3, diverting agent 300 is added to fluid flow 200 (e.g., slick water) and flows preferentially into first fracture type 104A. As diverting agent 300 flows into first fracture type 104A, the diverting agent will eventually form plug 302 in the first fracture type, as shown in FIG. 4. After plug 302 is formed, fluid flows into the other fracture types (e.g., second fracture type 104B and/or third fracture type 104C) and diverting agent 300 may eventually form plugs in the other fracture types. As diverting agent 300 plugs the fractures, the diverting agent will plug perforations 108 in wellbore 102 that are used to form the fractures.

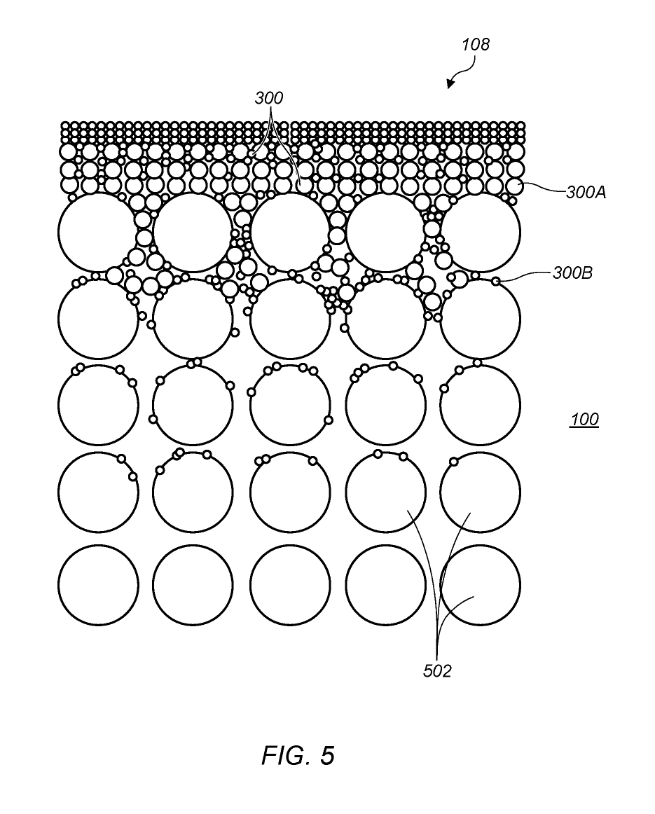

FIG. 5 depicts a schematic representation of an embodiment of a plug structure being formed in perforation 108 in formation 100 by diverting agent 300. Perforation 108 extends downwards, as shown in FIG. 5, from a wellbore (not shown)(e.g., diverting agent 300 enters perforation 108 at the top of the figure). In some embodiments, perforation 108, as shown in FIG. 5, includes at least a portion of a fracture formed in formation 100 through the perforation (e.g., fracture 104, shown in FIG. 1A). The fracture portion may be towards the bottom of perforation 108, as the perforation is oriented in FIG. 5. In certain embodiments, perforation 108 may include structures 502. Structures 502 may be proppant (e.g., proppant 110) or formation grains (e.g., sand or rock from the formation) in perforation 108.

In certain embodiments, diverting agent 300 includes acid soluble material. In some embodiments, diverting agent 300 is calcium carbonate. In some embodiments, diverting agent 300 includes a mixture of acid soluble materials. For example, diverting agent 300 may include a mixture of calcium carbonate and an acid soluble fiber. The acid soluble fiber may include, but not be limited, acid soluble polymer fiber and/or acid soluble mineral fiber. One example of an acid soluble polymer is hydroxyethylcellulose. One example of an acid soluble mineral fiber is mineral wool fiber. In certain embodiments, the acid soluble fibers includes fibers or particles with certain dimensions (sizes). In certain embodiments, the acid soluble fiber includes fibers with a diameter between about 0.1 mm and about 5 mm and a length between about 1 mm and about 30 mm.

In certain embodiments, diverting agent 300 includes particles that are sized appropriately for the size of perforation 108 (e.g., the size of the hole for the perforation). For example, calcium carbonate may be provided that has a certain size distribution based on the size (diameter) of perforation 108 and/or the width of the perforation. In some embodiments, diverting agent 300 includes particles (or particles and fibers) in two or more size ranges. For example, as shown in FIG. 5, diverting agent 300 may include particles in two size ranges (e.g., a bimodal distribution of diverting agent particles 300A and diverting agent particles 300B). It may also be possible to provide more than two size ranges in diverting agent 300 (e.g., three size ranges, four size ranges, etc.) as desired. The size ranges may be an average particle size with a distribution around the average particle size. For example, calcium carbonate may be provided with a particular mesh size, with the mesh size describing the average size and distribution of particles for the calcium carbonate. Examples of mesh sizes include, but are not limited to, mesh sizes between 5 mesh and 350 mesh. A bimodal distribution of particles may include, for example, 50% particles in a first mesh size range (e.g., about 20 mesh) and 50% particles in a second mesh size range (e.g., about 200 mesh).

In certain embodiments, diverting agent particles 300A have a larger size than diverting agent particles 300B. The larger diverting agent particles (particles 300A) may fill (e.g., bridge) the larger openings across or between structures 502, as shown in FIG. 5. The smaller diverting agent particles (particles 300B) may then fill in the smaller openings now created and reduce the permeability of the plug formed in perforation 108.

In some embodiments, the particles in the different size ranges are provided substantially simultaneously. For example, if both diverting agent particles 300A and diverting agent particles 300B are calcium carbonate, both sized particles may be provided substantially simultaneously (e.g., a bimodal distribution of calcium carbonate is provided). The larger particles may, however, flow to perforation 108 faster than the smaller particles.

In some embodiments, particles in a first size range are provided first followed by particles in a second size range. For example, larger diverting agent particles 300A may be provided first followed by smaller diverting agent particles 300B. In certain embodiments, diverting agent particles 300A provided first are acid soluble fibers and diverting agent particles 300B provided second are calcium carbonate. In such embodiments, the acid soluble fibers may form a fiber mat at or near perforation 108. The calcium carbonate may then fill the openings in the fiber mat to further reduce permeability of the plug formed in perforation 108. In some embodiments, the calcium carbonate provided after the acid soluble fibers is provided in a bimodal distribution (or another multiple mesh size distribution). The combination of diverting agent particles, however, may be varied as needed. For example, in some embodiments, the acid soluble fibers may be the smaller diverting agent particles or, in some, embodiments, both diverting agent particles may be calcium carbonate, as described above.

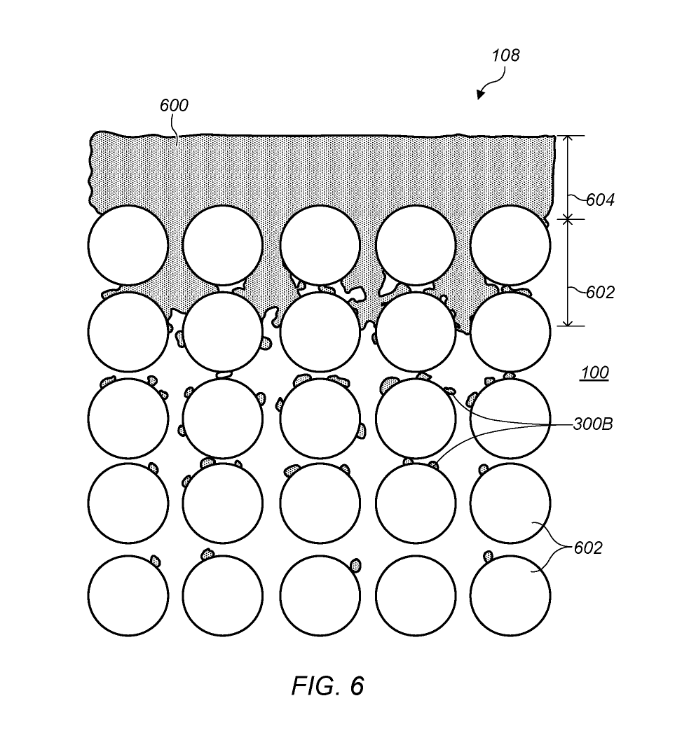

FIG. 6 depicts a schematic representation of an embodiment of plug 600, formed by diverting agent 300, shown in FIG. 5, filling perforation 108. Plug 600 may be, for example, a cake formed from diverting agent 300 (e.g., formed from diverting agent particles 300A and diverting agent particles 300B). In certain embodiments, as shown in FIG. 6, plug 600 includes internal filter cake 602 and external filter cake 604. Internal filter cake 602 may extend into formation 100 (e.g., in towards the fracture in formation 100). External filter cake 604 may plug the perforation in or near the wellbore (e.g., perforation 108 in wellbore 102, shown in FIG. 1A). In some embodiments, some diverting agent particles (e.g., smaller diverting agent particles 300B) attach to structures 502 in the lower portion of perforation 108 (e.g., towards the fracture in the formation). Plug 600, formed by diverting agent 300, may be more effective at diverting fluids (inhibiting flow) than plugs formed by typical diverting agents (e.g., polylactic acid plugs).

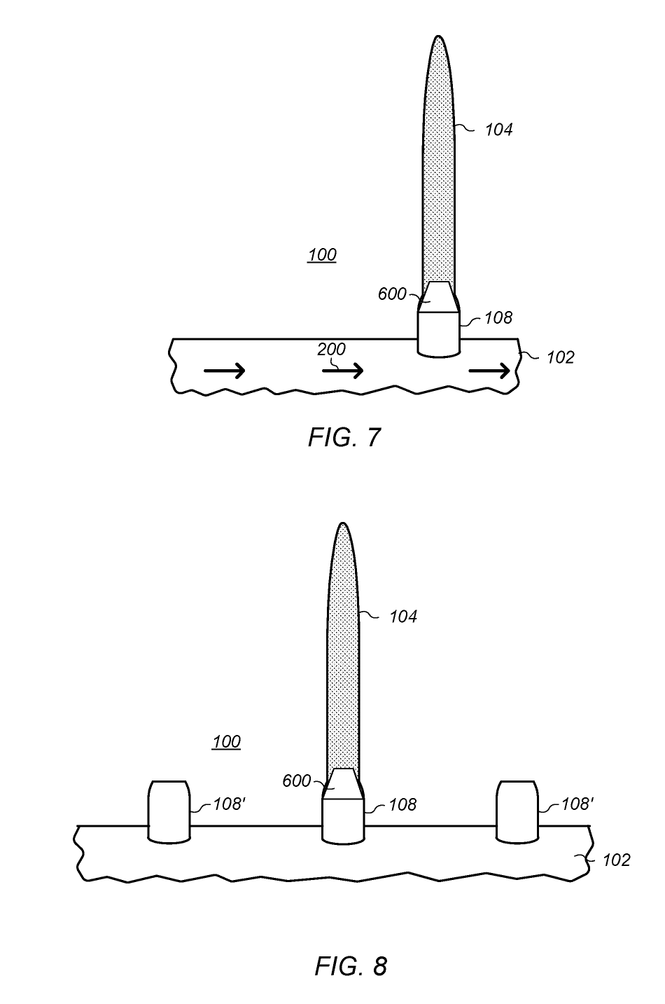

FIG. 7 depicts a schematic representation of an embodiment of plug 600 formed in perforation 108 on wellbore 102. After plug 600 is formed in perforation 108 (and in other perforations in the wellbore), the plug inhibits fluid flow into the perforation. Thus, any additional fluids (e.g., fluids 200) provided into wellbore 102 while plug 600 (and other plugs) is in place is diverted along the wellbore to other locations in the wellbore (e.g., the fluid is inhibited from flowing into fracture 104 coupled to perforation 108).

In certain embodiments, wellbore 102 is reperforated after diverting agent 300 (e.g., calcium carbonate and/or acid soluble fibers) forms plugs 600 in the wellbore. FIG. 8 depicts a schematic representation of an embodiment of reperforation of wellbore 102. Reperforation may form new perforations (e.g., second perforations 108′) in wellbore 102. Reperforation may be performed at any time as needed after diverting agent 300 is used to form plugs 600 in wellbore 102. Diverting agent 300 may remain in place in the plugs for any time desired as the diverting agent (e.g., calcium carbonate) is stable at all temperatures encountered in the wellbore (e.g., temperatures above ambient encountered in the wellbore). Thus, diverting agent 300 allows plugs 600 to be formed without the need for any special chemistry for specific temperatures within wellbore 102.

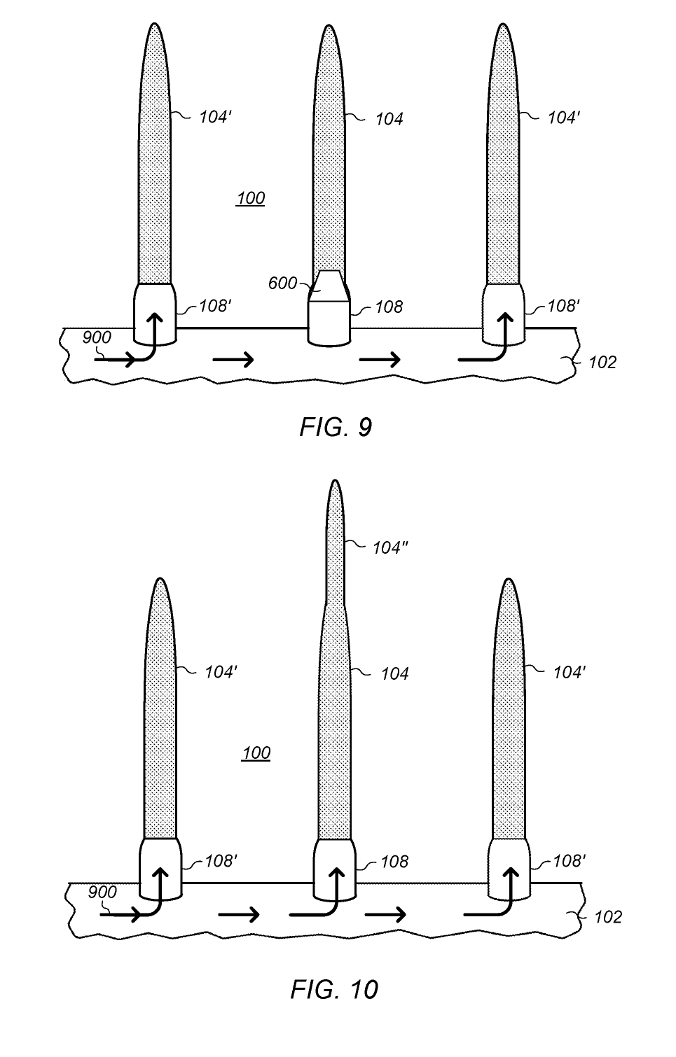

In certain embodiments, after reperforation of wellbore 102, fracking fluids (e.g., stimulation fluids) are provided into the wellbore to stimulate additional fractures in the formation (e.g., refracture the formation through the wellbore). FIG. 9 depicts a schematic representation of an embodiment of refracturing of wellbore 102 (e.g., forming new fractures from the wellbore). Fracking fluids 900 may be provided into wellbore 102. Fracking fluids 900 may be provided into wellbore 102 and flow through second perforations 108′ to form additional fractures 104′ in formation 100. Plugs 600, formed by diverting agent 300 in the first perforations (e.g., the perforations formed by the first fracturing process), inhibit fracking fluids 900 from flowing through the first perforations (e.g., perforation 108) and any fractures from being formed or extended through the first perforations.

In some embodiments, plugs 600 may be removed before stimulating fractures 104′ in wellbore 102 (e.g., by providing acid into the wellbore as described below). Removing plugs 600 before stimulating fractures in the wellbore may allow fractures to be extended and/or formed through the first perforations (perforations 108) formed in the first fracturing process in addition to the new perforations (perforations 108′) from reperforation. FIG. 10 depicts a schematic representation of an embodiment of refracturing of wellbore 102 with the plug removed. As shown in FIG. 10, fracture 104 may be extended by fracture 104″ in addition to fractures 104′ being formed from perforations 108′.

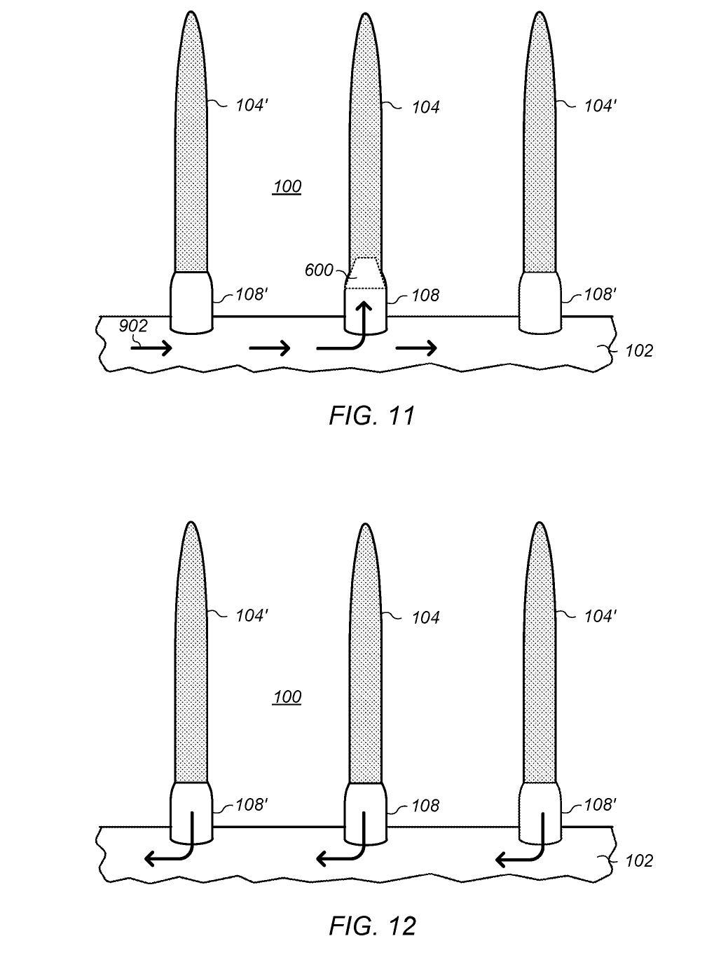

In certain embodiments, plugs 600 are removed after stimulating additional fractures using the refracturing process (e.g., providing the fracking fluids with the plugs in place, as shown in FIG. 9). FIG. 11 depicts a schematic representation of an embodiment of plug 600 being removed after the refracturing of wellbore 102 depicted in FIG. 9. In certain embodiments, plug 600 is removed by providing (introducing) acid 902 into wellbore 102 to dissolve the plug. Dissolving of plug 600 is represented by dotted lines in FIG. 11. Examples of acids that may be used include, but are not limited to, mineral or organic acids. In one embodiment, hydrochloric acid is used to remove plugs 600 formed by diverting agent 300. Using calcium carbonate and/or acid soluble fibers as the diverting agent and hydrochloric acid as the removal fluid provides a low cost method for forming and removing plugs 600 in wellbore 102. For example, using both calcium carbonate and hydrochloric acid may be ⅓ to ¼ the cost of other diverting agents typically used for refracturing.

Additionally, using hydrochloric acid to remove plug 600 provides a controllable method for removing the plug. Typically, plugs formed by diverting agents are removed by allowing the plugs to degrade over time at a certain temperature. Using calcium carbonate as the diverting agent, however, provides plugs that are temperature insensitive. Thus, acid 902 (e.g., hydrochloric acid) may be used at any time desired to remove plug 600 from wellbore 102. In addition, the calcium carbonate leaves little to no residue in the wellbore when removed by the acid and both calcium carbonate and hydrochloric acid are environmentally benign.

In certain embodiments, the diverting agent (e.g., diverting agent 300, shown in FIG. 3) includes a source of acid that is delayed. For example, the source of acid may be time delayed (e.g., a time delayed acid source). The time delayed acid source may be added to (combined with) acid soluble materials (e.g., calcium carbonate) in the diverting agent. In some embodiments, the time delayed acid source may combine with the acid soluble materials (e.g., calcium carbonate) to help form a plug in the wellbore (e.g., plug 302 or plug 600). Thus, plug 600, shown in FIGS. 7-9, may be formed with the time delayed source of acid inside or forming part of the plug. The time delayed acid source may provide acid in the wellbore on a desired schedule (e.g., time delayed acid source may degrade into acid or release acid on the desired schedule). For example, the time delayed acid source may provide acid in the wellbore at a specified time or over a controlled period of time. The acid provided by the time delayed acid source may be used to dissolve calcium carbonate and/or other acid soluble materials in the plug and assist in removing the plug, as shown in FIG. 11. In some embodiments, the acid provided by the time delayed acid source removes the plugs without additional acid being provided in the wellbore (e.g., without acid 902, shown in FIG. 11). In some embodiments, the acid provided by the time delayed acid source removes the plugs with additional acid also being provided in the wellbore (e.g., with acid 902, shown in FIG. 11).

In some embodiments, the time delayed acid source includes a polymer added to the diverting agent. For example, the polymer added to the diverting agent may be polylactic acid. Polylactic acid may degrade over time (e.g., on the desired schedule) to produce lactic acid in the wellbore (e.g., the polylactic acid is a source of lactic acid). The produced lactic acid may dissolve the acid soluble materials and help remove the plugs.

In some embodiments, the time delayed acid source includes an encapsulated mineral or organic acid. For example, hydrochloric acid or an organic acid such as citric acid may be encapsulated and added to the diverting agent. The encapsulated acid may be released on the desired schedule (e.g., over a controlled period of time), releasing acid in the wellbore that acts to dissolve the acid soluble materials and help remove the plugs.

After the plugs are removed, production may take place in the wellbore. FIG. 12 depicts a schematic representation of an embodiment of production from refractured wellbore 102. Removing the plugs allows production to take place through fractures formed during the original (or previous) fracturing process (e.g., fracture 104) and the additional fractures (e.g., fractures 104′) formed during the refracturing process, as shown by the arrows in FIG. 12.

Further modifications and alternative embodiments of various aspects of the embodiments described in this disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as the presently preferred embodiments. Elements and materials may be substituted for those illustrated and described herein, parts and processes may be reversed, and certain features of the embodiments may be utilized independently, all as would be apparent to one skilled in the art after having the benefit of this description. Changes may be made in the elements described herein without departing from the spirit and scope of the following claims.

What is claimed is:

1. A method for treating an oil and gas-bearing subsurface formation, comprising:
providing at least one acid soluble material into a wellbore in the oil-bearing subsurface formation, wherein the wellbore comprises a plurality of first perforations in the wellbore that have been used to form first fractures emanating from the wellbore in the formation, and wherein the at least one acid soluble material forms a plug in one or more of the first perforations, the plug inhibiting fluid flow through such first perforations;
forming one or more second perforations in the wellbore; and
providing one or more fracking fluids into the wellbore to hydraulically stimulate the formation and form second fractures in the formation through the second perforations in the wellbore, wherein formation of fractures through the first perforations is inhibited by the plugs formed by the at least one acid soluble material.

2. The method of claim 1, wherein the first perforations have been used to form the first fractures prior to providing the at least one acid soluble material into the wellbore.

3. The method of claim 1 or 2, wherein at least some hydrocarbons have been produced through the first fractures prior to providing the at least one acid soluble material into the wellbore.

4. The method of any one of claims 1-3, further comprising providing an acid into the wellbore to remove the plugs formed by the at least one acid soluble material.

5. The method of any one of claims 1-4, further comprising providing the at least one acid soluble material into the wellbore with water.

6. The method of any one of claims 1-5, further comprising producing hydrocarbon fluids from the wellbore.

7. The method of claim 6, wherein the produced hydrocarbon fluids include hydrocarbon fluids that flow into the wellbore from the first fractures and from the second fractures.

8. The method of any one of claims 1-7, wherein the at least one acid soluble material comprises at least a first acid soluble material and a second acid soluble material, and wherein the first acid soluble material comprises calcium carbonate.

9. The method of claim 8, wherein the second acid soluble material comprises an acid soluble fiber.

10. The method of claim 8, wherein the second acid soluble material comprises acid soluble fibers with a diameter between about 0.1 mm and about 5 mm and a length between about 1 mm and about 30 mm.

11. The method of any one of claims 1-10, wherein the at least one acid soluble material comprises calcium carbonate, and wherein the calcium carbonate comprises particles that are sized according to a size of the first perforations.

12. The method of any one of claims 1-11, wherein the at least one acid soluble material comprises calcium carbonate, and wherein the calcium carbonate comprises particles that are sized according to a width of the first fractures.

13. The method of any one of claims 1-12, wherein the at least one acid soluble material comprises calcium carbonate, wherein the calcium carbonate comprises particles of at least two sizes that are sized according to a size of the first perforations, and wherein the particles of a first size are larger than the particles of a second size.

14. The method of claim 13, wherein the particles of the first size are configured to bridge across openings in the first perforations, and wherein the particles of the second size are configured to reduce the permeability between the particles of the first size and other particles in the first perforations.

15. A method for treating an oil and gas-bearing subsurface formation, comprising:
providing a mixture of two or more acid soluble materials into a wellbore in the oil-bearing subsurface formation, wherein the wellbore comprises a plurality of first perforations in the wellbore that have been used to form first fractures in the formation emanating from the wellbore, and wherein at least two of the acid soluble materials combine to form a plug in one or more of the first perforations, the plug inhibiting fluid flow through such first perforations;
forming one or more second perforations in the wellbore; and
providing one or more fracking fluids into the wellbore to hydraulically stimulate the formation and form second fractures in the formation through the second perforations in the wellbore, wherein formation of fractures through the first perforations is inhibited by the plugs formed by the at least two acid soluble materials.

16. The method of claim 15, wherein the first perforations have been used to produce hydrocarbons from the formation before providing the mixture two or more acid soluble materials into the wellbore.

17. The method of claim 15 or claim 16, further comprising providing an acid into the wellbore to remove the plugs formed by the at least two acid soluble materials.

18. The method of any one of claims 15-17, further comprising providing the mixture of two or more acid soluble materials into the wellbore with water.

19. The method of any one of claims 15-18, further comprising producing hydrocarbon fluids from the wellbore.

20. The method of claim 19, wherein the hydrocarbon fluids are produced after removing one or more of the plugs by providing an acid into the wellbore.

21. The method of claim 19 or 20, wherein the produced hydrocarbon fluids include hydrocarbon fluids that flow into the wellbore from the first fractures and from the second fractures.

22. The method of any one of claims 15-21, wherein the mixture of acid soluble materials comprises a first acid soluble material and a second acid soluble material, and wherein the first acid soluble material comprises calcium carbonate.

23. The method of claim 22, wherein the first acid soluble material and the second acid soluble material combine to form the plug in one or more of the first perforations.

24. The method of claim 22 or 23, wherein the second acid soluble material comprises an acid soluble fiber.

25. The method of claim 22 or 23, wherein the second acid soluble material comprises acid soluble fibers with a diameter between about 0.1 mm and about 5 mm and a length between about 1 mm and about 30 mm.

26. A system configured to treat an oil and gas-bearing subsurface formation, comprising:
a first acid soluble material configured to be provided into a wellbore in the oil-bearing subsurface formation, the wellbore comprising a plurality of first perforations that have been used to hydraulically fracture the oil-bearing subsurface formation; and
a second acid soluble material, wherein the second acid soluble material is configured to combine with the second acid soluble material to form a plug in one or more of the first perforations to inhibit fluid flow through such first perforations.

27. The system of claim 26, wherein the first acid soluble material comprises calcium carbonate and the second acid soluble material comprises an acid soluble fiber.

28. The system of claim 26 or claim 27, wherein the second acid soluble material comprises acid soluble fibers with a diameter between about 0.1 mm and about 5 mm and a length between about 1 mm and about 30 mm.

29. A method for treating an oil and gas-bearing subsurface formation, comprising:
providing at least one acid soluble material into a wellbore in the oil-bearing subsurface formation, wherein the wellbore comprises a plurality of first perforations in the wellbore that have been used to form first fractures in the formation emanating from the wellbore, and wherein the at least one acid soluble material forms a plug in one or more of the first perforations, the plug inhibiting fluid flow through such first perforations;
forming one or more second perforations in the wellbore; and
providing an acid into the wellbore to remove the plugs formed by the at least one acid soluble material.

30. The method of claim 29, wherein the first perforations have been used to form the first fractures prior to providing the at least one acid soluble material into the wellbore.

31. The method of claim 29 or 30, wherein at least some hydrocarbons have been produced through the first fractures prior to providing the at least one acid soluble material into the wellbore.

32. The method of any one of claims 29-31, further comprising providing the at least one acid soluble material into the wellbore with water.

33. The method of any one of claims 29-32, wherein the at least one acid soluble material comprises at least a first acid soluble material and a second acid soluble material, and wherein the first acid soluble material comprises calcium carbonate.

34. The method of claim 33, wherein the second acid soluble material comprises an acid soluble fiber.

35. The method of claim 33, wherein the second acid soluble material comprises acid soluble fibers with a diameter between about 0.1 mm and about 5 mm and a length between about 1 mm and about 30 mm.

36. A method for treating an oil and gas-bearing subsurface formation, comprising:
providing a mixture of one or more acid soluble materials in combination with a delayed source of acid into a wellbore in the oil-bearing subsurface formation, wherein the wellbore comprises a plurality of first perforations in the wellbore that have been used to form first fractures in the formation emanating from the wellbore in a hydraulic fracturing process, and wherein at least one of the acid soluble materials and the delayed source of acid combine to form a plug in one or more of the first perforations, the plug inhibiting fluid flow through such first perforations;
forming one or more second perforations in the wellbore; and
providing one or more fracking fluids into the wellbore to hydraulically stimulate the formation and form second fractures in the formation through the second perforations in the wellbore, wherein formation of fractures through the first perforations is inhibited by the plugs formed by the at least one acid soluble material in combination with the delayed source of acid.

37. The method of claim 36, wherein the first perforations have been used to form the first fractures prior to providing the mixture of one or more acid soluble materials into the wellbore.

38. The method of claim 36 or 37, wherein at least some hydrocarbons have been produced through the first fractures prior to providing the mixture of one or more acid soluble materials into the wellbore.

39. The method of any one of claims 36-38, wherein the delayed source of acid comprises encapsulated mineral or organic acids.

40. The method of any one of claims 36-38, wherein the delayed source of acid comprises polymers or other chemicals that degrade over time to yield acid.

41. A method for treating an oil and gas-bearing subsurface formation, comprising:
providing a mixture of one or more acid soluble materials and a delayed source of acid into a wellbore in the oil-bearing subsurface formation, wherein the wellbore comprises a plurality of first perforations in the wellbore used to form first fractures in the formation emanating from the wellbore in a hydraulic fracturing process, and wherein at least one of the acid soluble materials and the delayed source of acid combine to form a plug in one or more of the first perforations, the plug inhibiting fluid flow through such first perforations;
forming one or more second perforations in the wellbore; and
allowing the delayed source of acid to form acid in the wellbore, wherein the acid removes the plugs formed by the at least one acid soluble material and the delayed source of acid.

42. The method of claim 41, wherein the first perforations have been used to form the first fractures prior to providing the mixture of one or more acid soluble materials and the delayed source of acid into the wellbore.

43. The method of claim 41 or 42, wherein at least some hydrocarbons have been produced through the first fractures prior to providing the mixture of one or more acid soluble materials and the delayed source of acid into the wellbore.

44. The method of any one of claims 41-43, wherein the delayed source of acid comprises encapsulated mineral or organic acids.

45. The method of any one of claims 41-43, wherein the delayed source of acid comprises polymers or other chemicals that degrade over time to yield acid.

46. A method for treating an oil and gas-bearing subsurface formation, comprising:
providing a mixture of one or more acid soluble materials and a delayed source of acid into a wellbore in the oil-bearing subsurface formation, wherein the wellbore comprises a plurality of first perforations in the wellbore used to form first fractures in the formation emanating from the wellbore in a hydraulic fracturing process, and wherein at least one of the acid soluble materials and the delayed source of acid combine to form a plug in one or more of the first perforations, the plug inhibiting fluid flow through such first perforations;
forming one or more second perforations in the wellbore;
allowing the delayed source of acid to form a first acid in the wellbore, wherein the first acid assists in removing the plugs formed by the at least one acid soluble material and the delayed source of acid; and
providing a second acid into the wellbore to assist in removing the plugs formed by the at least one acid soluble material and the delayed source of acid.

47. The method of claim 46, wherein the first perforations have been used to form the first fractures prior to providing the mixture of one or more acid soluble materials and the delayed source of acid into the wellbore.

48. The method of claim 46 or 47, wherein at least some hydrocarbons have been produced through the first fractures prior to providing the mixture of one or more acid soluble materials and the delayed source of acid into the wellbore.

49. The method of any one of claims 46-48, wherein the delayed source of acid comprises encapsulated mineral or organic acids.

50. The method of any one of claims 46-48, wherein the delayed source of acid comprises polymers or other chemicals that degrade over time to yield acid.

51. A method for treating an oil and gas-bearing subsurface formation, comprising:
providing at least one acid soluble material into a wellbore in the oil-bearing subsurface formation, wherein the wellbore comprises a plurality of first perforations in the wellbore, and wherein the at least one acid soluble material forms a plug in one or more of the first perforations;
forming one or more second perforations in the wellbore; and
providing one or more fracking fluids into the wellbore to hydraulically stimulate the formation and form fractures in the formation through the second perforations in the wellbore.
